(19) United States
(12) Patent Application Publication
(10) Pub. No.: US 2022/0195899 A1
(43) Pub. Date: Jun. 23, 2022

(54) DIAGNOSIS DEVICE FOR INTERNAL COMBUSTION ENGINE

(71) Applicant: ISUZU MOTORS LIMITED, Tokyo (JP)

(72) Inventor: Hideki OSADA, Fujisawa-shi, Kanagawa (JP)

(21) Appl. No.: 17/439,351

(22) PCT Filed: Mar. 13, 2020
(86) PCT No.: PCT/JP2020/011165

§ 371 Date: Sep. 14, 2021

(30) Foreign Application Priority Data
Mar. 15, 2019 (JP) 2019-048605

(51) Int. Cl. F01M 13/04; F02D 41/22

(52) U.S. Cl. CPC F01M 13/04; F02D 2250/08; F02D 41/222

(57) ABSTRACT

Provided is a diagnosis device for an internal combustion engine where the internal combustion engine includes a blow-by gas passage through which blow-by gas flows and the diagnosis device includes a temperature sensor which detects a temperature inside the blow-by gas passage and an abnormality detection unit which detects an abnormality in the internal combustion engine based on a detected value of the temperature sensor.

### TECHNICAL FIELD

The present disclosure relates to a diagnosis device for an internal combustion engine.

### BACKGROUND ART

In the internal combustion engine, a blow-by gas processing device which releases blow-by gas leaked into a crankcase from a gap between a piston and a cylinder to the atmosphere or returns it to an intake passage is known.

### CITATION LIST

### Patent Literature

Patent Literature 1: JP-UM-A-561-5309

### SUMMARY OF INVENTION

### Technical Problem

By the way, in the internal combustion engine, when a piston ring attached to the piston wears, for example, an abnormality such as an increase in blow-by gas may occur. Such an abnormality increases an amount of oil contained in the blow-by gas and cause malfunctions of the internal combustion engine, so the abnormality needs to be detected promptly.

The present disclosure provides a diagnosis device capable of detecting an abnormality in an internal combustion engine.

### Solution to Problem

According to an aspect of the present disclosure, there is provided a diagnosis device for an internal combustion engine where the internal combustion engine includes a blow-by gas passage through which blow-by gas flows and where the diagnosis device includes a temperature sensor which detects a temperature inside the blow-by gas passage and an abnormality detection unit which detects an abnormality in the internal combustion engine based on a detected value of the temperature sensor.

The abnormality detection unit may detect an abnormality by comparing the detected value of the temperature sensor with a threshold value and correct the threshold value based on at least one of an atmospheric temperature, a temperature of engine oil, and a temperature of engine cooling water.

In addition, the abnormality detection unit may correct the threshold value to a higher value as at least one of the atmospheric temperature, the temperature of engine oil, and the temperature of engine cooling water is higher.

In addition, the internal combustion engine may further include an oil separator provided in the blow-by gas passage for separating oil from blow-by gas and the temperature sensor may be located in the blow-by gas passage on a downstream side of the oil separator.

In addition, a downstream side end portion of the blow-by gas passage may be open to the atmosphere and the temperature sensor may be located at the downstream side end portion of the blow-by gas passage.

### Advantageous Effects of Invention

With the diagnosis device according to the present disclosure, an abnormality of the internal combustion engine can be detected based on the temperature in the blow-by gas passage.

### BRIEF DESCRIPTION OF DRAWINGS

FIG. 1 is a schematic configuration diagram of an internal combustion engine.

FIG. 2 is a diagram illustrating a temperature in a blow-by gas passage and a threshold value thereof.

FIG. 3 is a map which defines a relationship between the atmospheric temperature and a correction coefficient corresponding to the temperature.

FIG. 4 is a map which defines a relationship between a temperature of engine oil and a correction coefficient corresponding to the temperature.

FIG. 5 is a diagram illustrating a control flow of an abnormality detection unit.

FIG. 6 is a schematic configuration diagram of an internal combustion engine in a first modification example.

FIG. 7 is a schematic configuration diagram of an internal combustion engine in a second modification example.

FIG. 8 is a map which defines a relationship between a temperature of engine cooling water in the second modification example and a correction coefficient corresponding to the temperature.

FIG. 9 is a diagram illustrating a control flow of an abnormality detection unit in the second modification example.

FIG. 10 is a diagram illustrating a control flow of an abnormality detection unit in a third modification example.

### DESCRIPTION OF EMBODIMENTS

Hereinafter, embodiments of the present disclosure will be described with reference to the accompanying drawings. It should be noted that the present disclosure is not limited to the following embodiments. In addition, each of the up, down, left, and right directions illustrated in the figure is merely defined for convenience of explanation.

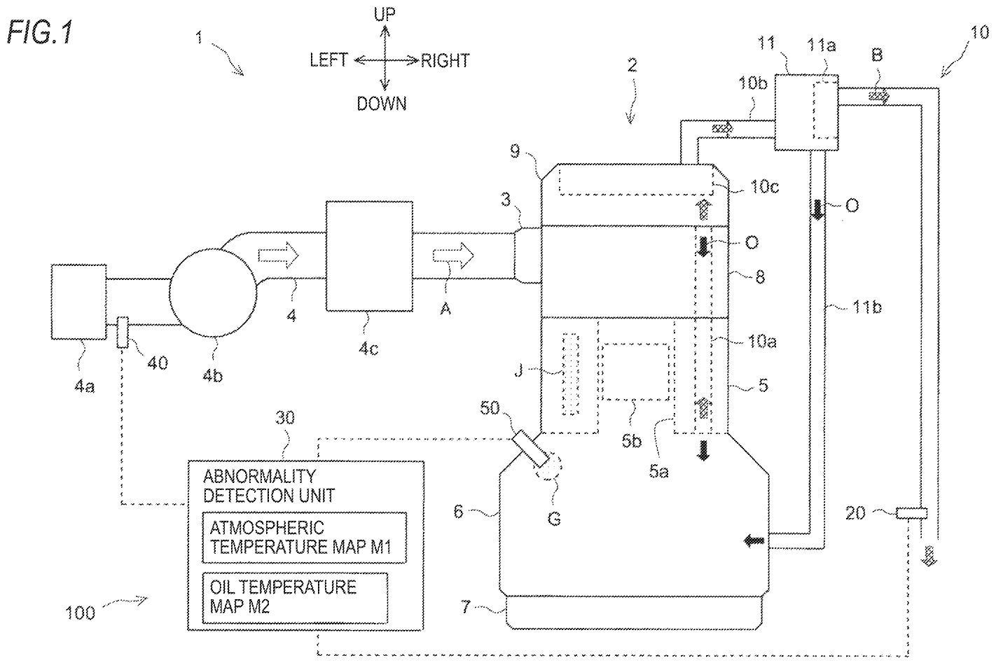

First, a schematic configuration of an internal combustion engine 1 will be described with reference to FIG. 1. In the figure, a white arrow A indicates flow of intake air and a shaded arrow B indicates flow of blow-by gas. Also, a black arrow O indicates flow of oil separated from the blow-by gas.

The internal combustion engine 1 is a multi-cylinder compression-ignition-type internal combustion engine, that is, a diesel engine mounted on a vehicle (not illustrated). The vehicle is a large vehicle such as a truck. However, there are no particular limitations on the type, form, use, and the like of the vehicle and the internal combustion engine 1. For example, the vehicle may be a small vehicle such as a passenger car, or the internal combustion engine 1 may be a spark-ignition-type internal combustion engine, that is, a gasoline engine.

The internal combustion engine 1 includes an engine body 2, an intake manifold 3 connected to the engine body 2, and an intake pipe 4 connected to an upstream end of the intake manifold 3. The internal combustion engine 1 also includes exhaust system parts such as an exhaust pipe (not illustrated), but the description thereof will be omitted here.

Further, as will be described in detail below, the internal combustion engine 1 of the embodiment includes a blow-by gas passage 10 through which blow-by gas flows. Further, the internal combustion engine 1 includes an oil separator 11 for separating oil from the blow-by gas.

The engine body 2 includes a cylinder block 5, a crankcase 6 integrally formed at a lower part of the cylinder block 5, and an oil pan 7 connected to a lower part of the crankcase 6. Further, the engine body 2 includes a cylinder head 8 connected to an upper part of the cylinder block 5 and a head cover 9 connected to an upper part of the cylinder head 8.

A plurality of cylinders 5a are provided in the cylinder block 5 and a piston 5b is accommodated in each cylinder 5a. A crankshaft (not illustrated) is accommodated in the crankcase 6 and engine oil is stored in the oil pan 7. Further, a valve operating mechanism (not illustrated) is attached to the cylinder head 8 and the valve operating mechanism is covered from above by the head cover 9. An oil gallery G in which engine oil is stored is formed in the crankcase 6. Further, a water jacket J through which engine cooling water is circulated is formed in the cylinder block 5 and the cylinder head 8.

The intake manifold 3 is connected to the cylinder head 8 and distributes and supplies the intake air sent from the intake pipe 4 to an intake port of each cylinder 5a. The intake pipe 4 is provided with an air cleaner 4a, a turbocharger compressor 4b, and an intercooler 4c in this order from the upstream side.

The blow-by gas passage 10 includes an in-engine passage 10a which passes through the inside of the engine body 2 and a blow-by gas pipe 10b exposed to the outside of the engine body 2 in order from the upstream side in a blow-by gas flow direction. As is well known, blow-by gas is gas which leaks into the crankcase 6 from a gap between the cylinder 5a and the piston 5b in the engine body 2. Although not illustrated, an amount of blow-by gas in the crankcase 6 is minimized by a plurality of piston rings attached to the pistons 5b.

The in-engine passage 10a passes through the inside of the cylinder block 5 and the cylinder head 8 from the inside of the crankcase 6 and communicates with the inside of the head cover 9.

For the blow-by gas pipe 10b, for example, a resin hose member is used. An upstream end of the blow-by gas pipe 10b is connected to an upper surface portion of the head cover 9. On the other hand, a downstream end of the blow-by gas pipe 10b is opened to the atmosphere at a height near a lower end of the engine body 2.

The in-engine passage 10a and the blow-by gas pipe 10b communicate with each other via an oil separation chamber 10c provided in an upper part of the head cover 9. Although not illustrated, the oil separation chamber 10c has a plurality of baffle plates and is configured to collide the blow-by gas introduced from the in-engine passage 10a with the baffle plates to separate the oil. Further, the oil separated from the blow-by gas is returned from the oil separation chamber 10c into the crankcase 6 through the in-engine passage 10a.

An oil separator 11 is provided outside the engine body 2 and in the middle of the blow-by gas pipe 10b. The oil separator 11 includes a filter element 11a for separating oil from the blow-by gas. However, the type of the oil separator 11 may be arbitrary and may be, for example, a centrifugal oil separator having no filter element.

Further, a return pipe 11b for returning oil O separated from the blow-by gas into the crankcase 6 is connected to the oil separator 11 of the embodiment. Further, although not illustrated, the oil separator 11 is provided with a bypass flow path for adjusting a flow rate which bypasses the filter element 11a and an on-off valve which opens and closes the bypass flow path.

According to the configuration described above, as illustrated by the arrow B in FIG. 1, while the internal combustion engine 1 is in operation, the blow-by gas in the crankcase 6 flows through the in-engine passage 10a and the blow-by gas pipe 10b in this order and is released into the atmosphere. In this case, the oil contained in the blow-by gas is separated from the blow-by gas by the oil separation chamber 10c and the oil separator 11.

Further, as illustrated by the arrow O in FIG. 1, the oil separated in the oil separation chamber 10c is returned to the crankcase 6 through the in-engine passage 10a. The oil separated by the oil separator 11 is returned to the crankcase 6 through the return pipe 11b.

Next, a diagnosis device 100 of the internal combustion engine 1 will be described in detail.

In the internal combustion engine 1, for example, an abnormality may occur in which the blow-by gas in the crankcase 6 increases due to wear or damage of the piston ring.

When the blow-by gas increases, the pressure inside the crankcase 6 increases. Therefore, it becomes difficult for the oil discharged from the oil separation chamber 10c to return to the inside of the crankcase 6 through the in-engine passage 10a. Also, the oil may flow back in the oil separation chamber 10c and flow into the blow-by gas pipe 10b together with the blow-by gas. Therefore, the blow-by gas containing a large amount of oil flows through the oil separator 11 and the blow-by gas on the downstream side of the oil separator 11 also contains a large amount of oil. As a result, a larger amount of oil than in a normal state may be released into the atmosphere.

Further, in the oil separator 11, abnormalities such as the on-off valve of the bypass flow path not closing and the connection flow path with the return pipe 11b being blocked may generate. In this case as well, there is a risk that a larger amount of oil than in the normal state will be released into the atmosphere.

Further, in the crankcase 6, when the blow-by gas increases, dilution of the engine oil due to the blow-by gas is likely to occur. Dilution causes the internal combustion engine 1 to fail.

In this respect, the inventor of the present application has newly discovered that the temperature (hereinafter, the in-pipe temperature) inside the blow-by gas pipe 10b tends to rise due to the heat of the oil contained in the blow-by gas when the above-described abnormality of the internal combustion engine 1 occurs. That is, the temperature of the oil contained in the blow-by gas is higher than the temperature of the blow-by gas itself. Therefore, under normal conditions, blow-by gas containing almost no oil flows in the blow-by gas pipe 10b, so that the in-pipe temperature becomes low. However, in the event of an abnormality, the blow-by gas containing a large amount of oil flows through the blow-by gas pipe 10b, so that the in-pipe temperature rises.

Therefore, the diagnosis device 100 of the embodiment includes a temperature sensor 20 which detects the in-pipe temperature and an abnormality detection unit 30 which detects an abnormality in the internal combustion engine 1 based on a detected value (hereinafter, a detected in-pipe temperature) of the temperature sensor 20.

Specifically, the temperature sensor 20 is attached to the blow-by gas pipe 10b. Although not illustrated, the abnormality detection unit 30 is composed of an electronic control unit (ECU) or a controller of the vehicle and includes a CPU, a ROM, a RAM, an input and output port, and the like. Further, the temperature sensor 20 is electrically connected to the abnormality detection unit 30.

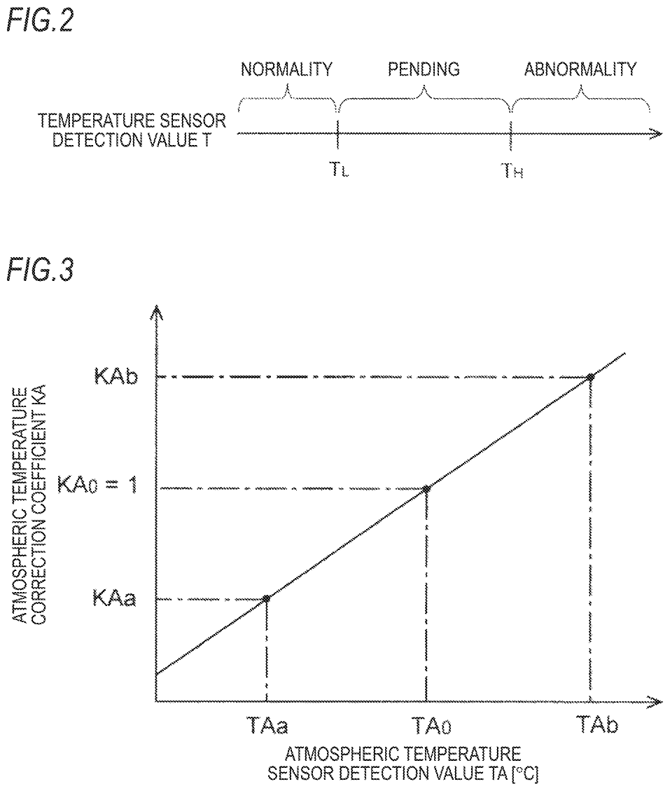

As illustrated in FIG. 2, the abnormality detection unit 30 compares a detected in-pipe temperature T with a predetermined normality threshold value T_{L} and detects that the internal combustion engine 1 is normal when the in-pipe temperature T is equal to or less than the normality threshold value T_{L}. Further, the abnormality detection unit 30 compares the detected in-pipe temperature T with a predetermined abnormality threshold value T_{H} and detects that the internal combustion engine 1 is abnormal when the detected in-pipe temperature T is equal to or higher than the abnormality threshold value T_{H}. The abnormality threshold value T_{H} corresponds to a threshold value described in the claims and is set to a temperature higher than the normality threshold value T_{L}(T_{H}>T_{L}). Then, when the abnormality detection unit 30 detects an abnormality in the internal combustion engine 1, a warning lamp (not illustrated) is turned on to notify a driver of the abnormality.

Therefore, the diagnosis device 100 according to the embodiment can detect an abnormality in the internal combustion engine 1 based on the temperature in the blow-by gas passage 10.

Further, the abnormality detection unit 30 of the embodiment holds this state without detecting the normality or abnormality of the internal combustion engine 1 when the detected in-pipe temperature T is less than the abnormality threshold value T_{H} and higher than the normality threshold value T_{L}. This enables reliable detection in consideration of the variation in the detected in-pipe temperature T.

Further, as illustrated in FIG. 1, the temperature sensor 20 of the embodiment is located on the blow-by gas pipe 10b on the downstream side of the oil separator 11. Although not illustrated, if the temperature sensor 20 is located on the blow-by gas pipe 10b on the upstream side of the oil separator 11, the detected in-pipe temperature becomes high even under normal conditions due to the blow-by gas before oil separation. Further, for example, even when the oil separator 11 is not provided on the blow-by gas pipe 10b, the detected in-pipe temperature may be high due to a similar reason. In these cases, a difference between the detected in-pipe temperatures T in the normal state and the abnormal state becomes small, and thus detection accuracy may decrease.

On the other hand, the temperature sensor 20 of the embodiment is located on the blow-by gas pipe 10b on the downstream side of the oil separator 11 and detects the temperature inside the pipe through which the blow-by gas flows after the oil is separated. Therefore, the detected in-pipe temperature T can be lowered in the normal state and the detected in-pipe temperature T can be raised in the abnormal state. As a result, a temperature difference between the normal state and the abnormal state becomes clear, and thus the detection accuracy can be improved.

Further, the temperature sensor 20 of the embodiment is located at a downstream side end portion of the blow-by gas pipe 10b opened to the atmosphere. In this way, at the time of the normal state, the temperature sensor 20 is susceptible to atmospheric temperature, so the detected in-pipe temperature T tends to be lower. On the other hand, at the time of the abnormal state, the detected in-pipe temperature T becomes high due to the influence of the heat of the oil contained in the blow-by gas. As a result, the temperature difference between the normal state and the abnormal state becomes more remarkable, and thus the detection accuracy of the normal state and the abnormal state can be improved.

Further, the detected in-pipe temperature T becomes higher as the atmospheric temperature and the engine oil temperature (hereinafter referred to as oil temperature) are higher. Therefore, when the above-described normality threshold value T_{L} and the abnormality threshold value T_{H} remain constant, there is a possibility that normal or abnormal is erroneously detected due to the atmospheric temperature and the oil temperature.

Therefore, the abnormality detection unit 30 of the embodiment corrects the normality threshold value T_{L} and the abnormality threshold value T_{H} based on the atmospheric temperature and the oil temperature.

Specifically, the diagnosis device 100 of the embodiment further includes an atmospheric temperature sensor 40 for detecting the atmospheric temperature and an oil temperature sensor 50 for detecting the oil temperature.

An air flow meter capable of detecting the intake flow rate and the atmospheric temperature is used for the atmospheric temperature sensor 40. The atmospheric temperature sensor 40 is attached to a part of the intake pipe 4 which is the part located on the upstream side of the compressor 4b and on the immediately downstream side of the air cleaner 4a in the intake flow direction. The oil temperature sensor 50 is attached to the oil gallery G of the crankcase 6. The atmospheric temperature sensor 40 and the oil temperature sensor 50 are electrically connected to the abnormality detection unit 30.

Also, as illustrated in FIG. 3, the abnormality detection unit 30 includes an atmospheric temperature map M1 which defines a relationship between a detected value (hereinafter, a detected atmospheric temperature) TA of the atmospheric temperature sensor 40 and a correction coefficient (hereinafter, an atmospheric temperature correction coefficient) KA corresponding to the detected atmospheric temperature TA.

In the atmospheric temperature map M1, the relationship between the detected atmospheric temperature TA and the atmospheric temperature correction coefficient KA is set so that the higher the detected atmospheric temperature TA is, the larger the atmospheric temperature correction coefficient KA is. Further, the atmospheric temperature map M1 stores a reference atmospheric temperature correction coefficient KA₀ (KA₀=1) corresponding to a predetermined reference atmospheric temperature TA₀ (for example, 25° C.).

In the illustrated example, an atmospheric temperature correction coefficient KAa (KAa<KA₀), which is smaller than the reference atmospheric temperature correction coefficient KA₀, is acquired corresponding to a detected atmospheric temperature TAa (TAa<TA₀) lower than the reference atmospheric temperature TA₀. Also, an atmospheric temperature correction coefficient KAb (KAb>KA₀) larger than the reference atmospheric temperature correction coefficient KA₀ is acquired corresponding to a detected atmospheric temperature TAb (TAb>TA₀) higher than the reference atmospheric temperature TA₀.

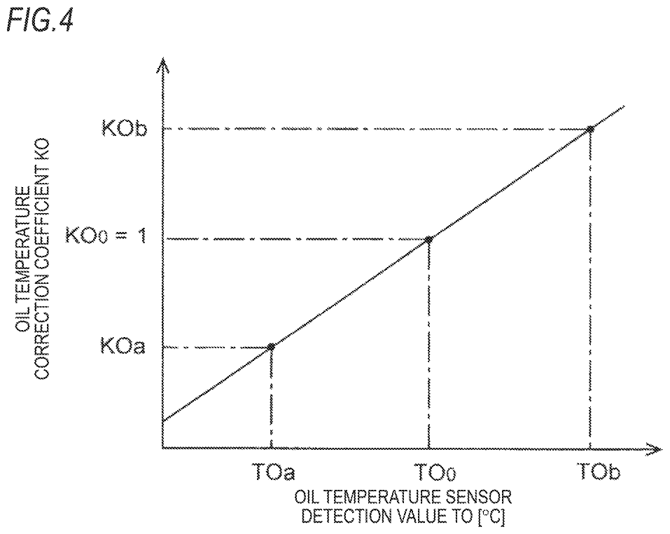

Also, as illustrated in FIG. 4, the abnormality detection unit 30 includes an oil temperature map M2 which defines a relationship between a detected value (hereinafter, detected oil temperature) TO of the oil temperature sensor 50 and a correction coefficient (hereinafter, oil temperature correction coefficient) KO corresponding to the detected oil temperature TO.

In the oil temperature map M2, the relationship between the detected oil temperature TO and the oil temperature correction coefficient KO is set so that the higher the detected oil temperature TO is, the larger the oil temperature correction coefficient KO is. Further, the oil temperature map M2 stores a reference oil temperature correction coefficient KO₀ (KO₀=1) corresponding to a predetermined reference oil temperature TO₀ (for example, 90° C.).

In the illustrated example, an oil temperature correction coefficient KOa (KOa<KO₀) smaller than the reference oil temperature correction coefficient KO₀ is acquired corresponding to a detected oil temperature TOa (TOa<TO₀) lower than the reference oil temperature TO₀. Also, an oil temperature correction coefficient KOb (KOb>KO₀) larger than the reference oil temperature correction coefficient KO₀ is acquired corresponding to a detected oil temperature TOb (TOb>TO₀) higher than the reference oil temperature TO₀.

The abnormality detection unit 30 calculates the corrected normality threshold value T_{L} by multiplying a reference normality threshold value T_{L0} before correction by the atmospheric temperature correction coefficient KA and the oil temperature correction coefficient KO (T_{L}=T_{L0}×KA×KO). Further, the abnormality detection unit 30 calculates the corrected abnormality threshold value T_{H} by multiplying a reference abnormality threshold value T_{H0} before correction by the atmospheric temperature correction coefficient KA and the oil temperature correction coefficient KO (T_{H}=T_{H0}×KA×KO).

Therefore, the normality threshold value T_{L} and the abnormality threshold value T_{H} are corrected to higher values as the detected atmospheric temperature TA and the detected oil temperature TO are higher and are corrected to lower values as the detected atmospheric temperature TA and the detected oil temperature TO are lower. As a result, erroneous detection due to the atmospheric temperature and the oil temperature can be suppressed.

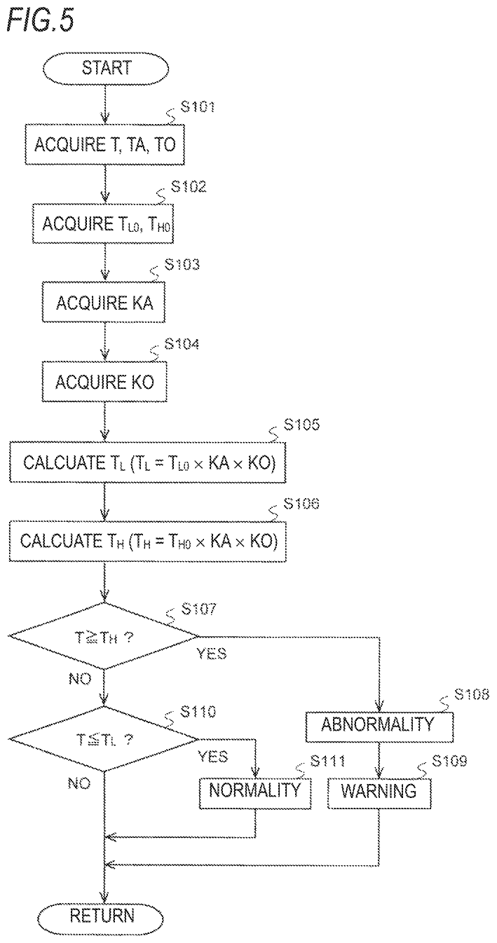

Next, a control routine of the abnormality detection unit 30 will be described with reference to FIG. 5.

The abnormality detection unit 30 repeatedly executes a control flow of FIG. 5 at predetermined calculation cycles (for example, 10 ms) while the internal combustion engine 1 is in a predetermined operation state (for example, idle operation state). As a result, the in-pipe temperature and the oil temperature, which fluctuate depending on the operation state of the internal combustion engine 1, can be detected under certain conditions.

In Step S101, the detected in-pipe temperature T, the detected atmospheric temperature TA, and the detected oil temperature TO are acquired. In Step S102, the reference normality threshold value T_{L0} and the reference abnormality threshold value T_{H0} are acquired.

In Step S103, the atmospheric temperature correction coefficient KA corresponding to the detected atmospheric temperature TA is acquired by referring to the atmospheric temperature map M1.

In Step S104, the oil temperature correction coefficient KO corresponding to the detected oil temperature TO is acquired by referring to the oil temperature map M2.

In Step S105, the corrected normality threshold value T_{L} is calculated by multiplying the reference normality threshold value T_{L0} by the atmospheric temperature correction coefficient KA and the oil temperature correction coefficient KO (T_{L}=T_{L0}×KA×KO).

In Step S106, the corrected abnormality threshold value T_{H} is calculated by multiplying the reference abnormality threshold value T_{H0} by the atmospheric temperature correction coefficient KA and the oil temperature correction coefficient KO (T_{H0}×KA×KO).

In Step S107, it is determined whether the detected in-pipe temperature T acquired in Step S101 is equal to or greater than the abnormality threshold value T_{H} (T≥T_{H}). When it is determined in Step S107 that the detected in-pipe temperature T is equal to or greater than the abnormality threshold value T_{H} (T≥T_{H}) (YES), the process proceeds to Step S108 and it is detected that the internal combustion engine 1 is abnormal. Then, the process proceeds to Step S109 and a warning lamp is turned on, and then the process returns.

On the other hand, when it is determined in Step S107 that the detected in-pipe temperature T is not equal to or greater than the abnormality threshold value T_{H} (T≥T_{H}) (NO), the process proceeds to Step S110 and it is determined whether the detected in-pipe temperature T is equal to or less than the normality threshold value T_{L} (T≤T_{L}).

When it is determined in Step S110 that the detected in-pipe temperature T is equal to or less than the normality threshold value T_{L} (T≤T_{L}) (YES), the process proceeds to Step S111 and it is detected that the internal combustion engine 1 is normal, and then the process returns.

On the other hand, when it is determined in Step S110 that the detected in-pipe temperature T is not equal to or less than the normality threshold value T_{L} (T≤T_{L}) (NO), the process returns in a pending state in which neither abnormality nor normality is detected.

The embodiment described above can be modification examples as follows or a combination thereof. In the following description, the same reference numerals and letters are used for the same components as those in the embodiment described above and detailed description thereof will be omitted.

### FIRST MODIFICATION EXAMPLE

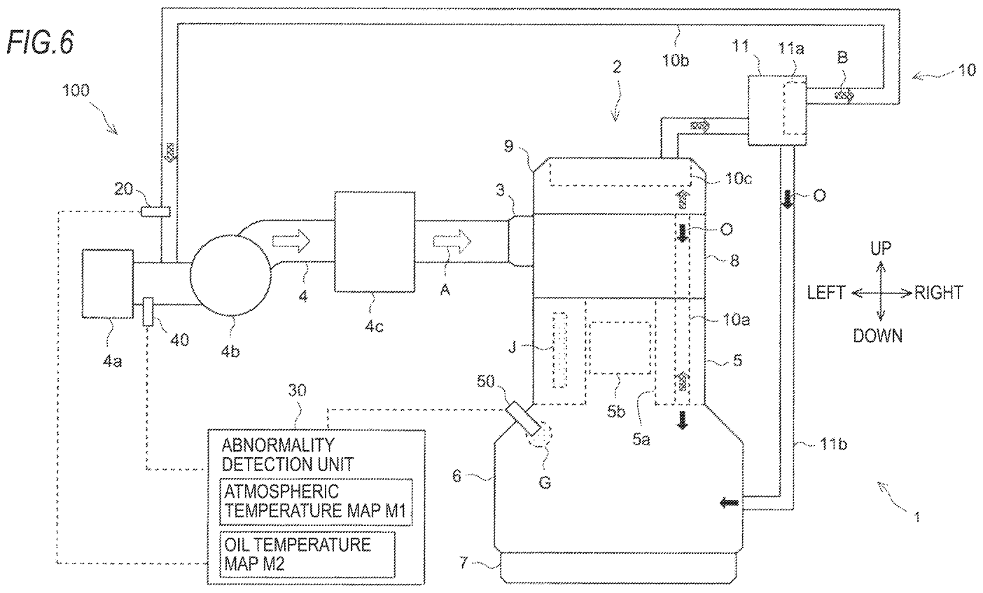

The blow-by gas may be returned to the intake pipe 4 without being released into the atmosphere from the blow-by gas pipe 10b. Specifically, as illustrated in FIG. 6, a downstream end of the blow-by gas pipe 10b of a first modification example is connected to a part of the intake pipe 4 which is the part located between the atmospheric temperature sensor 40 and the compressor 4b.

### SECOND MODIFICATION EXAMPLE

Parameters other than the atmospheric temperature and the oil temperature may be used to correct the normality threshold value T_{L} and the abnormality threshold value T_{H}.

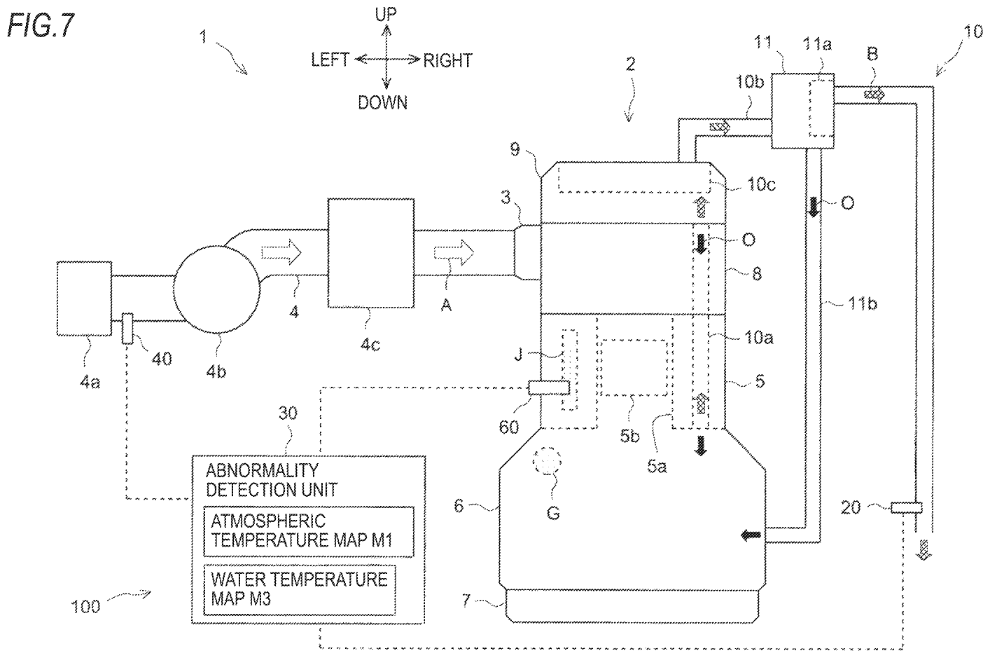

For example, as illustrated in FIGS. 7 to 9, in a second modification example, a temperature (hereinafter, referred to as the water temperature) of the engine cooling water is used instead of the oil temperature in the correction of the normality threshold value T_{L} and the abnormality threshold value T_{H}. Since the engine cooling water has a correlation with the oil temperature only at a temperature lower than the oil temperature by a certain temperature (for example, 10° C.), it can be a parameter for correcting the threshold values T_{L} and T_{H} as similar to the oil temperature.

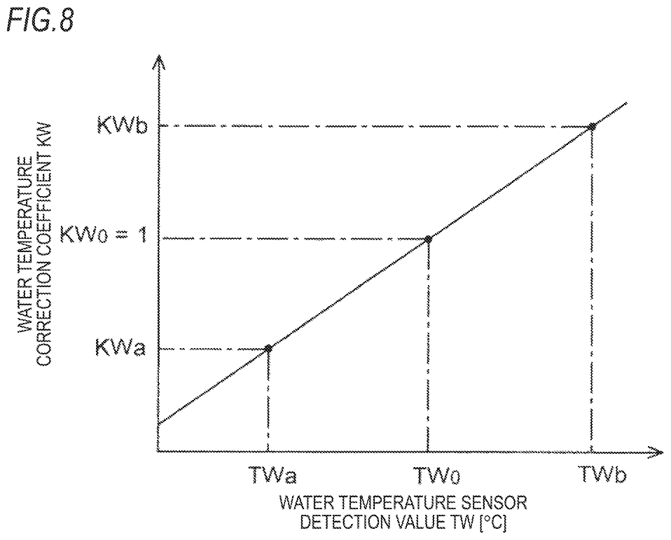

Specifically, as illustrated in FIG. 7, in the second modification example, the oil temperature sensor 50 is omitted, and instead, a water temperature sensor 60 attached to the water jacket J to detect the water temperature is used. Further, the abnormality detection unit 30 of the second modification example includes a water temperature map M3 instead of the oil temperature map M2. As illustrated in FIG. 8, with respect to the oil temperature map M2 illustrated in FIG. 4, the water temperature map M3 replaces the detected oil temperature TO with a detected value (hereinafter, detected water temperature) TW of the water temperature sensor 60 and replaces the oil temperature correction coefficient KO with a correction coefficient (hereinafter, water temperature correction coefficient) KW corresponding to the detected water temperature TW.

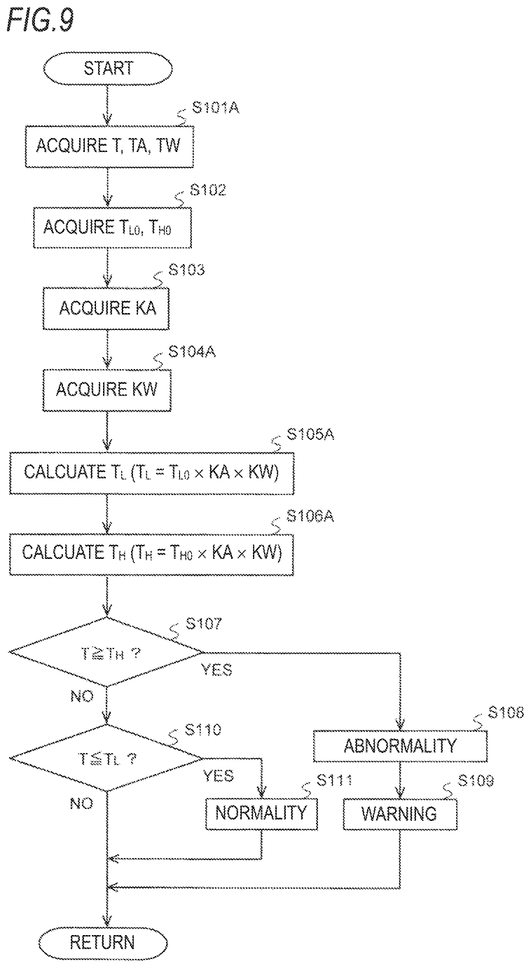

Further, as illustrated in FIG. 9, in a control flow of the second modification example, Steps S101 and 104 to 106 illustrated in FIG. 5 are replaced with Steps S101A and 104A to 106A. In Step S101A, the detected in-pipe temperature T, the detected atmospheric temperature TA, and the detected water temperature TW are acquired, and in Step S104A, the water temperature correction coefficient KW is acquired. Then, in Steps S105A and S106A, the normality threshold value T_{L} and the abnormality threshold value T_{H} are calculated based on the atmospheric temperature correction coefficient KA and the water temperature correction coefficient KW.

### THIRD MODIFICATION EXAMPLE

In addition to the atmospheric temperature and the oil temperature, other parameters may be used to correct the normality threshold value T_{L} and the abnormality threshold value T_{H}.

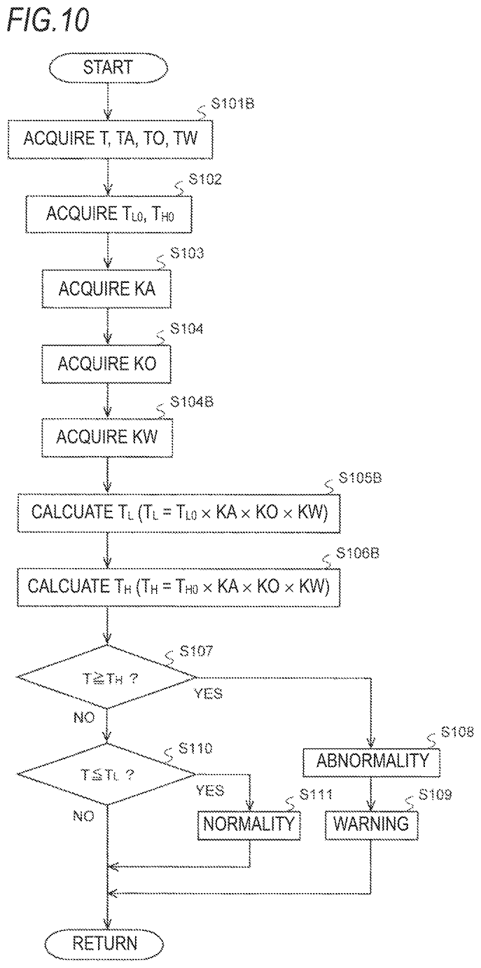

Specifically, as illustrated in FIG. 10, in a control flow of a third modification example, the water temperature is used as a parameter and Steps S101, S105, and S106 illustrated in FIG. 5 are replaced with Steps S101B, S105B, and S106B. Further, Step S104B is provided between Step S104 and Step S105B. In Step S101B, the detected in-pipe temperature T, the detected atmospheric temperature TA, the detected oil temperature TO, and the detected water temperature TW are acquired, and in step S104B, the water temperature correction coefficient KW is acquired. Then, in Steps S105B and S106B, the normality threshold value T_{L} and the abnormality threshold value T_{H} are calculated based on the atmospheric temperature correction coefficient KA, the oil temperature correction coefficient KO, and the water temperature correction coefficient KW.

### FOURTH MODIFICATION EXAMPLE

The normality threshold value T_{L} and the abnormality threshold value T_{H} may be corrected based on only one parameter (for example, atmospheric temperature).

### FIFTH MODIFICATION EXAMPLE

Although not illustrated, the normality threshold value T_{L} and the abnormality threshold value T_{H} need not be corrected. Specifically, the abnormality detection unit 30 of a fifth modification example compares the detected in-pipe temperature T with the reference normality threshold value T_{L0} and the reference abnormality threshold value T_{H0} to detect the normality and abnormality of the internal combustion engine.

### SIXTH MODIFICATION EXAMPLE

Instead of correcting the normality threshold value T_{L} and the abnormality threshold value T_{H}, the detected in-pipe temperature T may be corrected. Specifically, the abnormality detection unit 30 of a sixth modification example calculates a corrected detected in-pipe temperature T′ by dividing the detected in-pipe temperature T by the atmospheric temperature correction coefficient KA and the oil temperature correction coefficient KO (T′=T/(KA×KO)). Then, the corrected detected in-pipe temperature T′ is compared with the reference normality threshold value T_{L0} and the reference abnormality threshold value T_{H0} to detect the normality and abnormality of the internal combustion engine.

### SEVENTH MODIFICATION EXAMPLE

Of the normality threshold value T_{L} and the abnormality threshold value T_{H}, the normality threshold value T_{L} may be omitted. In a seventh modification example, only whether the detected in-pipe temperature T is equal to or greater than the abnormality threshold value T_{H} is determined.

### EIGHTH MODIFICATION EXAMPLE

When the temperature difference between the detected in-pipe temperatures T during normal and abnormal conditions is clear, the oil separator 11 may be omitted from the blow-by gas pipe 10b.

### NINTH MODIFICATION EXAMPLE

When the temperature difference between the detected in-pipe temperatures T during normal and abnormal conditions is clear, the temperature sensor 20 does not have to be located at the downstream side end portion of the blow-by gas pipe 10b. For example, the temperature sensor 20 of the ninth modification example is attached to the blow-by gas pipe 10b located immediately downstream of the oil separator 11.

The embodiment of the present disclosure is described in detail above. However, embodiments of the present disclosure are not limited to the embodiment described above and all modification examples, applications, and equivalents included in the ideas of the present disclosure defined by the claims are included in the present disclosure. Therefore, this disclosure should not be construed in a limited way and may be applied to any other technique which falls within the scope of the ideas of this disclosure.

This application is based on a Japanese patent application filed on Mar. 15, 2019 (Japanese Patent Application No. 2019-048605), the contents of which are incorporated herein by reference.

### INDUSTRIAL APPLICABILITY

With the diagnosis device according to the present disclosure, the abnormality of the internal combustion engine can be detected based on the temperature in the blow-by gas passage.

### REFERENCE SIGNS LIST

1: internal combustion engine

2: engine body

3: intake manifold

4: intake pipe

5: cylinder block

6: crankcase

7: oil pan

8: cylinder head

9: head cover

10: blow-by gas passage

10a: in-engine passage

10b: blow-by gas pipe

10c: oil separation chamber

11: oil separator

20: temperature sensor

30: abnormality detection unit

40: atmospheric temperature sensor

50: oil temperature sensor

100: diagnosis device

A: intake air

B: blow-by gas

O: oil separated from blow-by gas

T_{L}: normality threshold value

T_{H}: abnormality threshold value (threshold value)

1. A diagnosis device for an internal combustion engine, the internal combustion engine comprising a blow-by gas passage through which blow-by gas flows, the diagnosis device comprising:
a temperature sensor which detects a temperature inside the blow-by gas passage; and
an abnormality detector which detects an abnormality in the internal combustion engine based on a detected value of the temperature sensor.

2. The diagnosis device for the internal combustion engine according to claim 1,
wherein the abnormality detector detects an abnormality by comparing the detected value of the temperature sensor with a threshold value, and corrects the threshold value based on at least one of an atmospheric temperature, a temperature of engine oil, and a temperature of engine cooling water.

3. The diagnosis device for the internal combustion engine according to claim 2,
wherein the abnormality detector corrects the threshold value to a higher value as at least one of the atmospheric temperature, the temperature of engine oil, and the temperature of engine cooling water is higher.

4. The diagnosis device for the internal combustion engine according to claim 1,
wherein the internal combustion engine further includes an oil separator provided in the blow-by gas passage for separating oil from blow-by gas, and
wherein the temperature sensor is located in the blow-by gas passage on a downstream side of the oil separator.

5. The diagnosis device for the internal combustion engine according to claim 1,
wherein a downstream side end portion of the blow-by gas passage is open to the atmosphere, and
wherein the temperature sensor is located at the downstream side end portion of the blow-by gas passage.
